(19) United States
(12) Patent Application Publication
(10) Pub. No.: US 2009/0081915 A1
(43) Pub. Date: Mar. 26, 2009

(54) BURNING APPARATUS FOR FLUORESCENT LAMP

(76) Inventor: Jun Ho LEE, Seongnam-si (KR)

Correspondence Address: KED & ASSOCIATES, LLP, P.O. Box 221200, Chantilly, VA, 20153-1200, US

(21) Appl. No.: 12/132,117

(22) Filed: Jun. 3, 2008

(30) Foreign Application Priority Data
Sep. 20, 2007 (KR) 10-2007-0095912
Sep. 20, 2007 (KR) 10-2007-0096101

(51) Int. Cl. H01J 9/00

(52) U.S. Cl. 445/60

(57) ABSTRACT

A burning apparatus comprises at least one furnace, at least one conveyor to transfer a quartz tube containing at least one fluorescent bulb near the furnace, and a quartz tube holder for holding the quartz tube on the conveyor. The apparatus may further include a rotating device for rotating the quartz tube held by the quartz tube holder. The rotating device may include at least one roller that is in rolling contact with the quartz tube.

### BACKGROUND

1. Field

One or more embodiments described herein relates to lamps.

2. Background

A liquid crystal display panel is a non-emissive device that requires a backight unit (BLU) in order to clearly display images on a screen. The light source for the backlight unit may be a fluorescent lamp having a diameter of several millimeters. Examples of fluorescent lamps include cold cathode fluorescent lamps (CCFL) and external electrode fluorescent lamps (EEFL). The process of manufacturing these lamps requires improvement.

### BRIEF DESCRIPTION OF THE DRAWINGS

FIGS. 1 and 2 show one type of fluorescent lamp.

FIG. 3 shows a bulb of a lamp loaded into a quartz tube.

FIGS. 4 and 5 show one type of burning apparatus for a fluorescent lamp.

FIGS. 6 and 7 show parts of the burning apparatus.

FIGS. 5A to 5D show operation of the burning apparatus.

FIGS. 9 and 10 show an embodiment of another type of burning apparatus for heating a fluorescent lamp.

FIGS. 11 to 15 show parts of the burning apparatus of FIG. 10.

FIG. 16 shows another aspect of the burning apparatus of FIG. 10.

### DETAILED DESCRIPTION

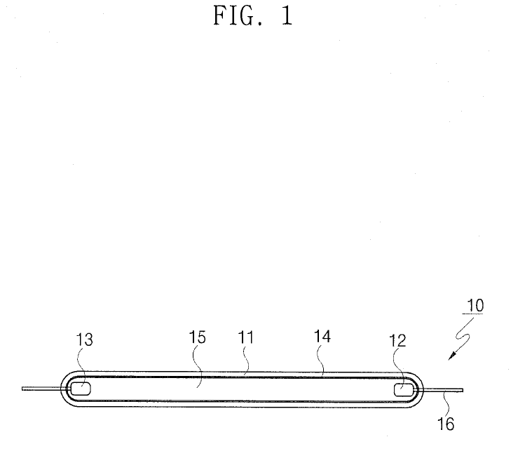

FIG. 1 shows one type of a cold cathode fluorescent lamp 10 which includes a long glass tube forming a bulb 11, an anode electrode 12, and a cathode electrode 13. The anode and cathode electrodes are attached to respective ends of the bulb. The lamp further includes a lead 16 extending from the electrodes of the bulb. A fluorescent material 14 is coated on an inner wall of the bulb and a mixed gas (such as mercury, argon, and neon) is filled in an inner space 15 of the bulb.

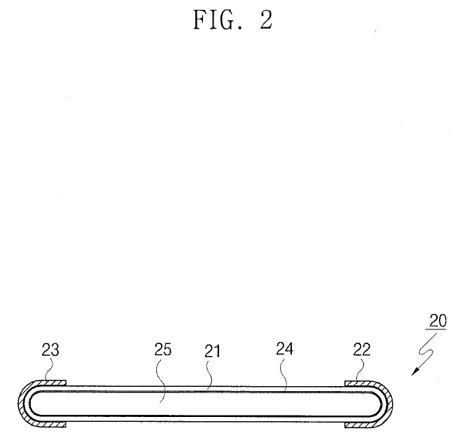

FIG. 2 shows one type of an external electrode fluorescent lamp 20. This lamp has both ends of a bulb 21 sealed and electrodes 22 and 23 are provided to externally surround ends of the lamp. An electric field is formed in the bulb by the electrodes to cause electricity to be discharged through gas in the bulb. A fluorescent material 24 is coated on an inner wall of the bulb and the gas may be a mixed gas (such as mercury, argon, and neon) filled in an inner space 25 of the bulb.

In order to manufacture cold cathode or external electrode fluorescent lamps, a process of applying a coating of fluorescent material on the inside of the bulb must be performed. This process must be followed by a process of burning the fluorescent material for stabilization purposes.

To perform the burning process, a burning apparatus loads the bulb coated with a fluorescent material between an upper furnace and a lower furnace. The heated bulb is then removed, thus completing the burning process.

Because each bulb is made of a very thin glass tube, bulbs may bump against each other and get broken during loading and unloading for the burning process. Also, bulbs may be broken when they are rotated to uniformly receive heat from the upper and lower furnaces.

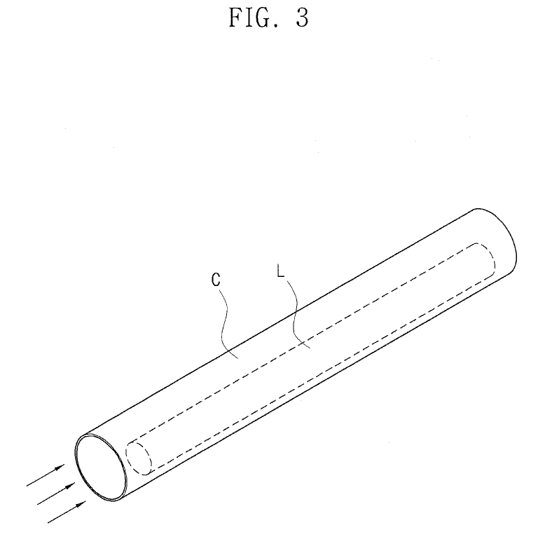

To solve such a problem, as shown in FIG. 3, bulb L may be inserted into a quartz tube C while it is loaded, rotated, and unloaded throughout the burning process. The use of a quartz tube can prevent the bulb from being broken and can also ensure continuity of the process. Although FIG. 3 shows only one bulb inserted into quartz tube C, a plurality of (e.g., three) bulbs may be inserted into each quartz tube if desired.

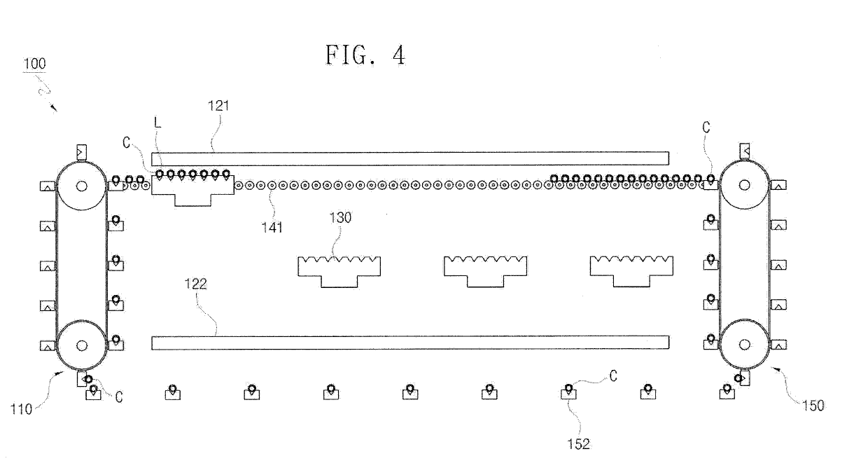

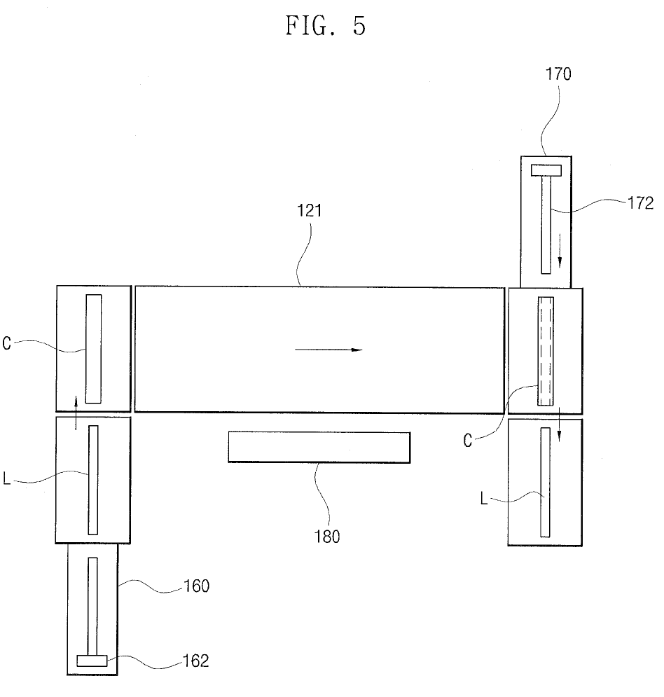

FIGS. 4 and 5 show a burning apparatus to be used for carrying out a burning process for a fluorescent lamp. This apparatus 100 includes a quartz tube loading lift 110, a loading unit 160 for loading a bulb L into the quartz tube C, a plurality of transfer blocks 130 for transferring the quartz tube between an upper furnace 121 and a lower furnace 122, a rotating roller 141 for rotating the quartz tube transferred by the transfer blocks, an unloading unit 170 for unloading the heated bulb from the quartz tube, a quartz tube unloading lift 150, and a collecting conveyor 152 for transferring the quartz tube after it has been moved down by the unloading lift to the loading lift. The loading unit 160 and the unloading unit 170 comprise pushers 162 and 172, respectively.

An injection device 180 for injecting high pressure air into the quartz tube rotated by rotating roller 141 is further provided to discharge foreign materials and gas generated during the burning process of the bulb.

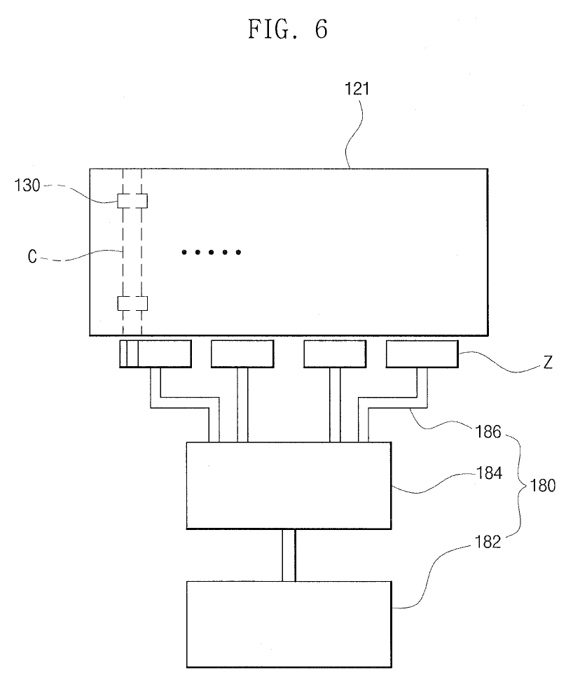

As shown in FIG. 6, the injection device 180 injects high temperature and high pressure air from one side to the other side of the quartz tube, as the tube passes through heating furnace 121. The quartz tube is transferred at a predetermined pitch and at a predetermined time interval and stays at each position for a predetermined period of time. Then, the tube is transferred to the next position. At this time, the injection device may supply high pressure air to a zone Z including several positions at which the quartz tube stays or to each of the respective positions.

The injection device includes a blower 182 for supplying air, a heater 184 for heating the air supplied from the blower, and a supply pipe 186 for supplying high pressure air from the heater to each of the quartz tubes.

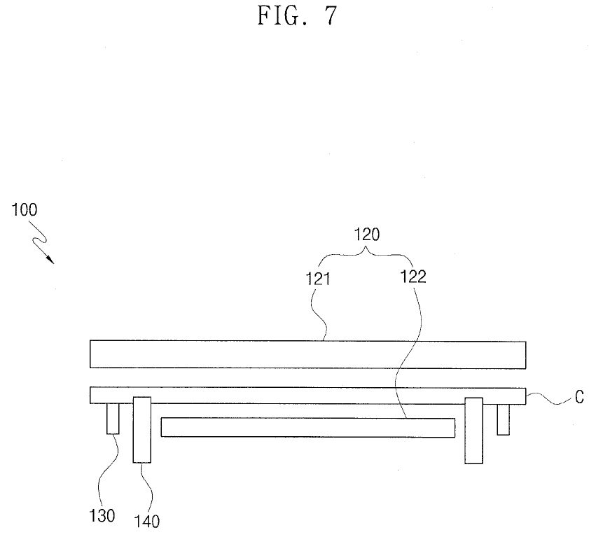

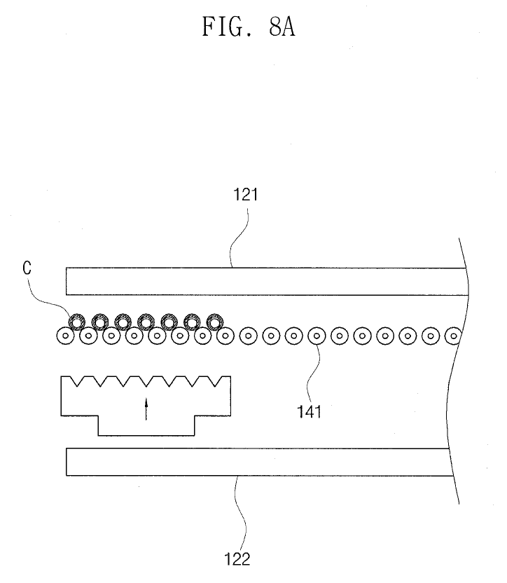

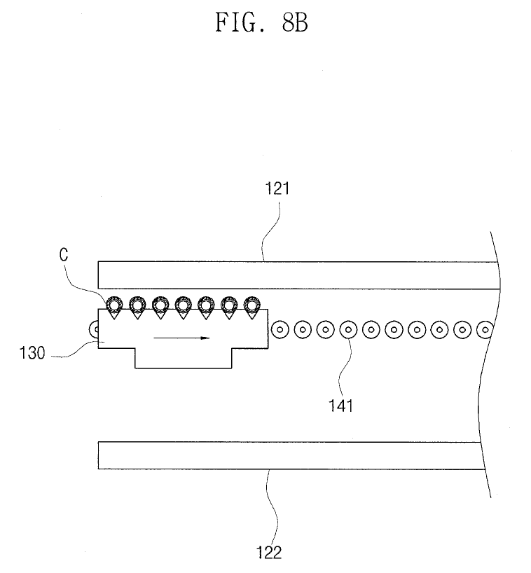

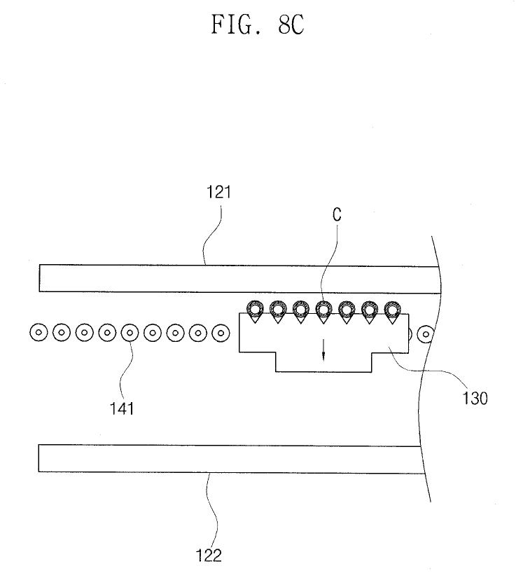

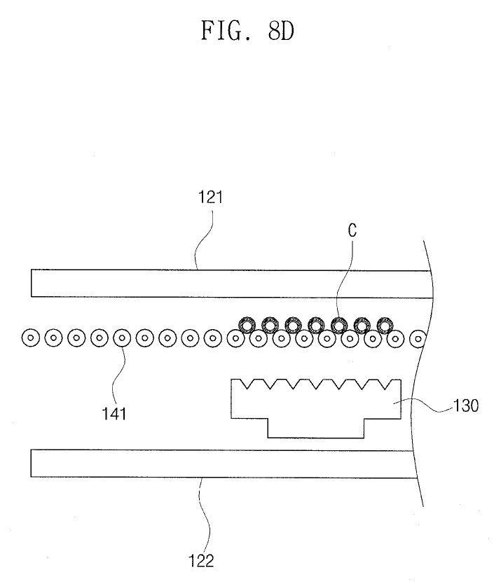

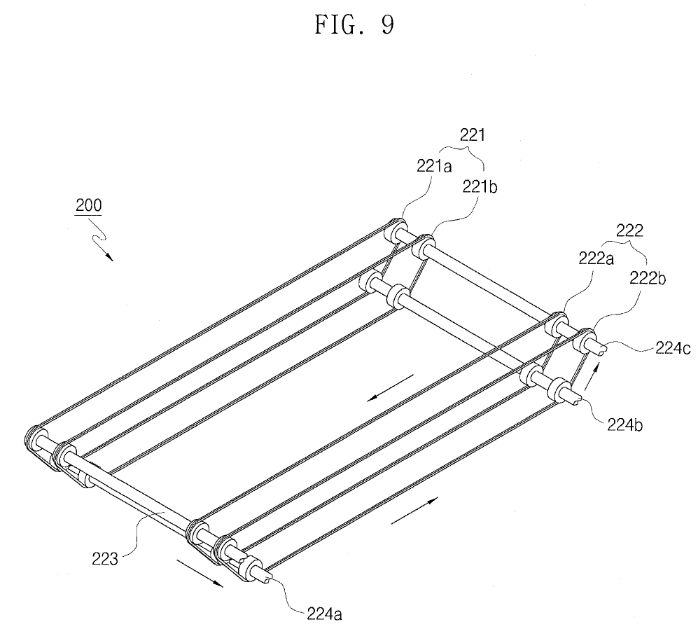

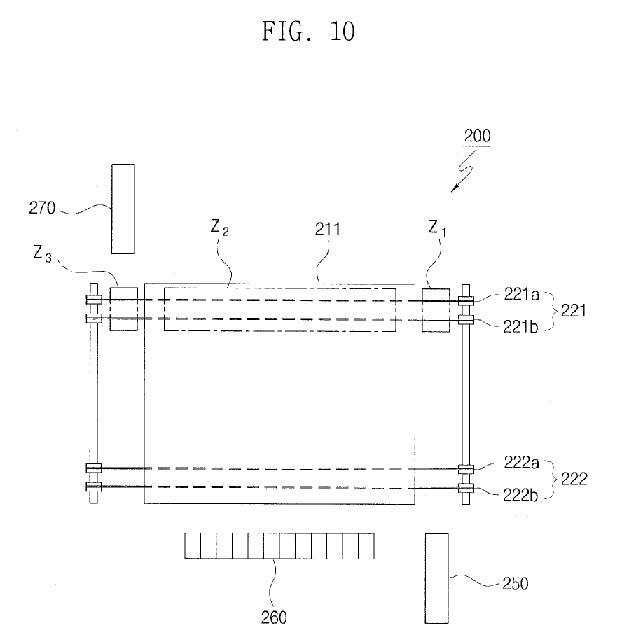

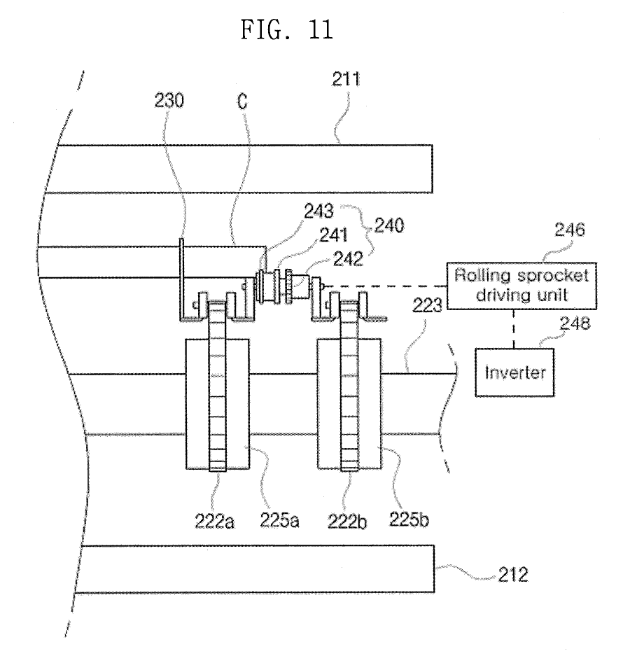

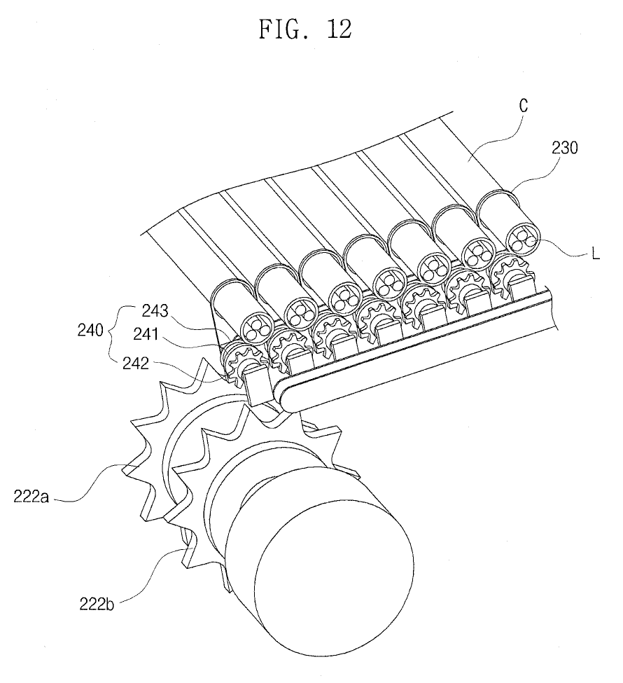

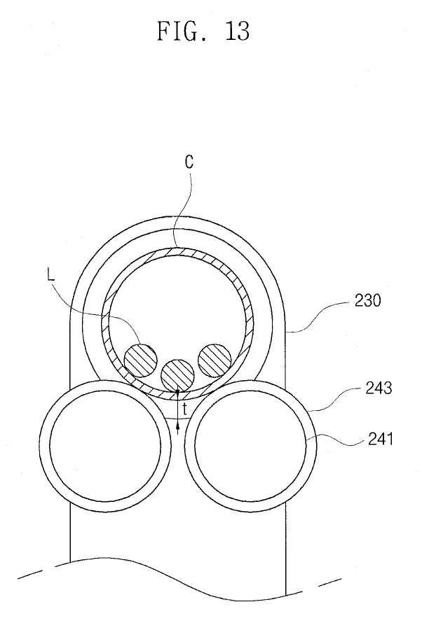

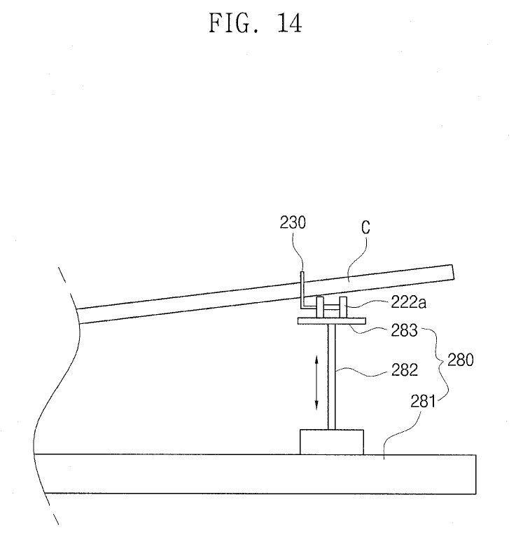

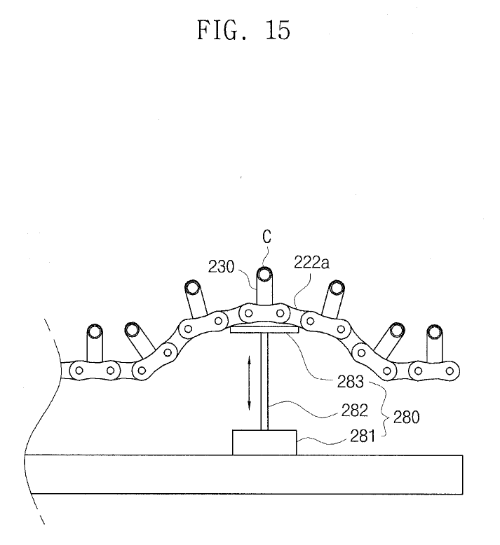

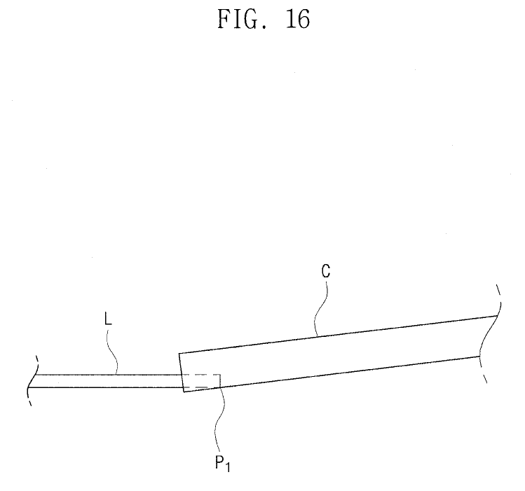

Referring to FIG. 7, the transfer blocks 130 and a rotating device 140 including the rotating roller 141 shown in FIG. 4 are disposed between the upper furnace 121 and the lower furnace 122. The transfer block is cam-driven and overlaps the rotating roller to transfer the quartz tube to the next rotating roller. Multiple transfer blocks may be used and each quartz tube may be transferred by a predetermined section of a block.

The rotating roller rotates the quartz tube transferred from the transfer block. The reason for rotating the quartz tube is to prevent the bulb loaded therein from being bent. That is, since the bulb is a thin and long glass tube, if heat is applied, the bulb may be bend. This can be prevented by rotation of the quartz tube. Multiple rotating rollers may be provided and each roller may include a sprocket connected by a chain.

Operation of the burning apparatus will be described with reference to FIGS. 8A to 8D. First, bulbs are inserted into quartz tubes C and lifted by the quartz tube loading lift. The quartz tubes are rotated between the upper furnace 121 and the lower furnace 122 by rotating rollers 141 to heat the bulbs. In this state, the first transfer block 130 is lifted by a cam driver (see FIG. 8A).

When first transfer block 130 is lifted, the quartz tubes are transferred from the rotating rollers to the first transfer block (see FIG. 8B). If the quartz tubes are transferred by a predetermined section while repeating the above process, the second transfer block is operated to transfer the quartz tubes in the same direction. As a result, the burning process is completed and the bulbs are unloaded.

A burning apparatus of the aforementioned typed is complicated, since the lift for loading and unloading the quartz tubes and the cam driver of the transfer blocks are essentially provided.

Moreover, since the transfer block is cam-driven, it is necessary to maintain a space required for cam driving between the upper and lower furnaces. Accordingly, the interval between the upper and lower furnaces may be increased, which results in an increase in the distance between the quartz tube and the heating furnaces, thus causing heat loss.

Furthermore, since the quartz tube cannot be rotated during transfer by the transfer blocks, the bulb may bend. Also, when the bulb is pushed and loaded into the quartz tube by the pusher, an outer circumference of the bulb is in frictional contact with the inner circumference of the quartz tube, thus causing scratches. Further, when the bulb is unloaded from the quartz tube by the pusher, the pusher pushes the bulb by fully penetrating the quartz tube, and thus it takes a long time to unload the bulb.

FIGS. 9-11 show an embodiment of another type of burning apparatus for heating a fluorescent lamp. This apparatus includes upper and lower furnaces 211 and 212, conveyors 221 and 222, a loading unit 250, a blower 260, and an unloading unit 270. The upper furnace is provided at a top of the conveyor and the lower furnace is disposed between ring-shaped conveyors.

Each conveyor is preferably a chain conveyor, in which a chain is rotated by a main sprocket provided on a drive shaft 223 and follower shafts 224a, 224b, and 224c. As can be seen from FIG. 9, the chains may be provided at both ends of the drive shaft and the follower shafts in double rows.

The loading unit 250 for inserting a bulb into a quartz tube is provided at one side of the moving section of the chains, and the unloading unit 270 for discharging the burnt bulb from the quartz tube is provided at the other side. The loading and unloading units may include, for example, pushers which expand and contract like an air cylinder such as shown in FIG. 5.

An injection device (blower) 260 for injecting high pressure air into quartz tube C is provided in a middle portion of the moving section of the chains. The injection device discharges foreign materials or gas generated in the quartz tube during a burning (heating) process. This injection device may be formed as shown in FIG. 6.

The burning apparatus further includes one or more tilting devices for raising one side of the quartz tube at a position Z1 where the bulb is loaded into the quartz tube, at a position Z3 where the bulb is unloaded from the quartz tube, and at a position Z2 where high temperature and high pressure air is injected into the quartz tube, respectively.

Referring to FIGS. 11 and 12, since the chains are provided in double rows, a pair of main sprockets 225a and 225b may be provided at ends of the drive shaft 223 or follower shafts 224a and 224b, respectively.

Moreover, a ring-shaped quartz tube holder 230 is connected to an inner chain 222a of the chains provided in double rows. That is, both ends of quartz tube C pass through a pair of the quartz tube holders 230 connected to a pair of inner chains 222b and 222a, and thus the quartz tube C is mounted therein. Accordingly, it can be understood that, when the main sprockets 225a and 225b are rotated, the quartz tube holder 230 and the quartz tube C mounted therein are transferred along with the chains 222a and 222b.

A quartz tube rotating device 240 for rotating the quartz tube is disposed between the pair of main sprockets 225a and 225b. The quartz tube rotating device includes a plurality of rollers 241 in rolling contact with the quartz tube in the quartz tube holder 230, a rolling sprocket 242 for transmitting the driving force to the rollers 241, and a rolling sprocket driving unit (not shown) for rotating the rolling sprocket 242. In particular, an O-ring 243, which may be formed of a Viton material, is provided on the outer circumference of rollers 241. Each quartz tube may include one or more lamps.

In order to prevent scratches from forming on the outer circumference of the quartz tube when the tube is rotated, quartz tube holder 230 and the quartz tube preferably do not contact each other. For this, as shown in FIG. 13, quartz tube C is rotated by a pair of rollers 241. These rollers are in rolling contact with the quartz tube, while supporting the tube with a gap “t” so that the quartz tube and tube holder do not contact each other. Because the O-ring is disposed on the outer circumference of rollers 241, the O-ring is at least substantially in direct contact with the quartz tube.

Referring to FIGS. 14 and 15, one embodiment of the tilting device 280 includes a base plate 281 positioned at the bottom of the chain 222a, a support 282 provided vertically to the base plate 281 and capable of adjusting the height thereof, and a support plate 283 provided at the top of the support and supporting the chain.

One or more tilting devices may be installed at a position Z1 where the bulb is loaded into the quartz tube, at a position Z3 where the bulb L is unloaded from the quartz tube, and at a position Z2 where high temperature and high pressure air is injected into the quartz tube, respectively, so as to raise one side of the quartz tube to be tilted at each of the above positions.

Although the configurations and operations of the tilting devices at the respective positions appear to be the same, their functions are different. First, as shown in FIG. 16, the reason quartz tube C is tilted at position Z1 where bulb L is loaded into the quartz tube is to bring the bulb into point contact with the quartz tube.

If the quartz tube is not tilted, the outer circumference of the bulb may be in line contact with the inner circumference of the quartz tube. Because the bulb is in point contact with the quartz tube, the bulb has no friction with the quartz tube other than a contact point P1, and thus no scratches are formed on the outer circumference of the bulb. Accordingly, the opposite side of the quartz tube into which the pusher is inserted should be raised.

The reason the quartz tube is tilted at position Z3 where the bulb is unloaded from the quartz tube is to facilitate the unloading process. That is, when the pusher is inserted into one side of the quartz tube to push the bulb to be unloaded, if the other side of the quartz tube is tilted downward, the unloading process may be facilitated by the tilt.

The reason that the quartz tube is tilted at position Z2 where high temperature and high pressure air is injected into the quartz tube is to facilitate discharge of foreign materials or gas generated in the quartz tube. That is, when air is injected into one side of the quartz tube to discharge foreign materials or gas, if the other side of the quartz tube is tilted upward, the high temperature air may be easily discharged to the other side of the quartz tube.

Operation of the burning apparatus 200 will now be described. First, loading unit 250 loads at least one bulb L into quartz tube C mounted on quartz tube holder 230. When the main sprockets 225 and 225b are driven by a predetermined section and stopped, the quartz tube is transferred between upper furnace 211 and lower furnace 212.

In this state, when the tolling sprocket 242 is driven, rollers 241 rotate the quartz tube, in non-contact with the quartz tube holder, without any friction. Because O-ring 243 of Viton material is disposed on the outer circumference of rollers 241, it is possible to rotate the quartz tube without slipping. When the quartz tube is rotated by rollers 241 for a predetermined period of time, heat is uniformly applied to the quartz tube and thus the bulb loaded into the quartz tube is heated.

After a predetermined period of time elapses in this state, main sprockets 225 and 225b are driven again to transfer the quartz tube along with the chains 221 and 222 by a predetermined section. Because the quartz tube is in contact with rollers 241 while the tube is transferred, the quartz tube can be rotated during transfer. However, since the quartz tube is rotated by the transfer of chains 221 and 222 in addition to being rotated by rollers 241, the rotational speed is changed.

In order to maintain the rotational speed of the quartz tube to be constant, any one of a variety of known inverters may be provided to regulate the rotational speed or the rotational direction of the rollers. For example, if the rotational direction of the quartz tube by the transfer of chains 221 and 222 is the same as that of the quartz tube when it is rotated by rollers 241, the rotational speed of the quartz tube is increased during transfer. In this case, the inverter will serve to reduce the rotational speed of the rollers to maintain the rotational speed of the quartz tube at a constant rate.

The burning process of the fluorescent lamp is therefore completed in the following order: loading→transfer and rotation→rotation→transfer and rotation→ . . . →unloading.

Even after the quartz tube is unloaded upon completion of the heating process of bulb L, the quartz tube being mounted in the quartz tube holder may be continuously transferred along chains 221 and 222. Then, when the quartz tube is positioned at the loading unit 250, a new bulb L is loaded therein. Moreover, high pressure air may be injected into the quartz tube during the burning process to forcibly discharge foreign materials or gas generated in the quartz tube.

One or more embodiments disclosed herein therefore provide a burning apparatus for a fluorescent lamp which is capable of easily loading and loading a bulb of the lamp. These embodiments may also be applied to easily discharge foreign materials or gas generated in a quartz tube during a burning process. These embodiments also transfer a quartz tube using a conveyor during a burning process.

According to one embodiment, the burning apparatus includes: a heating furnace; a conveyor provided at the top or at the bottom of the heating furnace and transferring a quartz tube; and a quartz tube holder for mounting the quartz tube on the conveyor. The heating furnace may include an upper furnace provided at the top of the conveyor and a lower furnace provided between the conveyors. The conveyor may be a chain conveyor provided at both ends of a drive shaft and a follower shaft. The chain conveyor may be provided at both ends of the drive shaft and the follower shaft in double rows. One end of the quartz tube holder may be connected to the conveyor and moved together with the conveyor.

The apparatus may further include a quartz tube rotating means for rotating the quartz tube mounted on the quartz tube holder. The quartz tube rotating means may be a roller being in rolling contact with the quartz tube. A friction member may be provided on the outer circumference of the roller. The friction member may be an O-ring. The friction member may be formed of a Viton material. The quartz tube being supported by a pair of the rollers may be in rolling contact with the pair of rollers so that the quartz tube may be in non-contact with the quartz tube holder.

The apparatus may further include an inverter for regulating the rotational speed or the rotational direction of the rollers. The apparatus may further include a loading unit for loading a bulb into the quartz tube, an unloading unit for unloading the bulb loaded into the quartz tube and burned, and a tilting means for tilting the quartz tube in a direction that the bulb is discharged at a position where the bulb is loaded or unloaded into or from the quartz tube. The tilting means may be provided to raise one side of the quartz tube.

The apparatus may further include an injection means for injecting high pressure air into the quartz tube transferred by the conveyor. The apparatus may further include a tilting means for tilting the quartz tube at a position where the high pressure air is injected. The tilting means may be provided to raise one side of the quartz tube.

A burning apparatus for a fluorescent lamp in accordance with one or more of the foregoing embodiments may therefore achieve the following advantages. Since the bulb is loaded into the quartz tube in a tilted state, it is possible to prevent scratches from forming on an outer circumference of the quartz tube or lamp. Moreover, since the bulb is unloaded from the quartz tube in a tilted state, the unloading process is easily and efficiently facilitated. Also, because one side of the quartz tube is tilted when high pressure air is injected into the quartz tube, it is possible to easily discharge foreign materials or gas. In addition, because the quartz tube is transferred by the conveyor, it is possible to maintain the burning temperature constant and minimize the heat loss. Additionally, since the quartz tube is rotated during transfer, it is possible to prevent the quartz tube from bending. Moreover, a cam driving device is not required and thus the apparatus is simplified.

Furthermore, since the quartz tube is fixed mounted on the conveyor, a lift required to load and unload the quartz tube is not required, thus simplifying the apparatus and reducing the process time. In addition, it is possible to prevent the quartz tube and the bulb from being damaged.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments of the present invention have been described with reference to a number of illustrative embodiments thereof, it should be understood that numerous other modifications and embodiments can be devised by those skilled in the art that will fall within the spirit and scope of the principles of this invention. More particularly, reasonable variations and modifications are possible in the component parts and/or arrangements of the subject combination arrangement within the scope of the foregoing disclosure, the drawings and the appended claims without departing from the spirit of the invention. In addition to variations and modifications in the component parts and/or arrangements, alternative uses will also be apparent to those skilled in the art.

What is claimed is:

1. A burning apparatus, comprising:
at least one furnace;
at least one conveyor to transfer a quartz tube containing at least one fluorescent bulb near the furnace; and
a quartz tube holder for holding the quartz tube on the conveyor.

2. The apparatus of claim 1, further comprising:
an upper furnace provided at a top of a first conveyor; and
a lower furnace provided between the first conveyor and a second conveyor.

3. The apparatus of claim 1, wherein the conveyor includes a chain conveyor provided at respective ends of a drive shaft and a follower shaft.

4. The apparatus of claim 3, wherein the chain conveyor is provided at both ends of the drive shaft and the follower shaft in double rows.

5. The apparatus of claim 1, wherein one end of the quartz tube holder is connected to and moved with the conveyor.

6. The apparatus of claim 1, further comprising:
a quartz tube rotating device for rotating the quartz tube held by the quartz tube holder.

7. The apparatus of claim 6, wherein the quartz tube rotating device includes at least one roller that is in rolling contact with the quartz tube.

8. The apparatus of claim 7, wherein a friction member is provided on an outer circumference of the roller.

9. The apparatus of claim 8, wherein the friction member is an O-ring.

10. The apparatus of claim 8, wherein the friction member is formed of a Viton material.

11. The apparatus of claim 7, wherein the quartz tube is supported by a pair of rollers, the pair of rollers holding quartz tube so that the tube does not contact the quartz tube holder.

12. The apparatus of claim 7, further comprising:
an inverter for regulating a rotational speed or a rotational direction of the at least one roller.

13. The apparatus of claim 1, further comprising:
a loading unit for loading a bulb into the quartz tube;
an unloading unit for unloading the bulb loaded into the quartz tube after the tube is heated by the furnace; and
a tilting device for tilting the quartz tube in a direction to allow the bulb to be discharged at a position where the bulb is loaded or unloaded into or from the quartz tube.

14. The apparatus of claim 13, wherein the tilting device raises one side of the quartz tube during loading or unloading of the bulb.

15. The apparatus of claim 13, further comprising:
an injection device for injecting high pressure air into the quartz tube transferred by the conveyor.

16. The apparatus of claim 15, further comprising:
a tilting device for tilting the quartz tube at a position where the high pressure air is injected.

17. The apparatus of claim 16, wherein the tilting device raises one side of the quartz tube.
